(19) United States
(12) Patent Application Publication
(10) Pub. No.: US 2017/0262893 A1
(43) Pub. Date: Sep. 14, 2017

(54) DISTRIBUTION USING SOCIAL PROXIMITY

(71) Applicant: International Business Machines Corporation, Armonk, NY (US)

(72) Inventors: Datta S. Khot, Pune (IN); Abhir S. Kulkarni, Pune (IN); Vikas C. Roy, Pune (IN); Anurag Srivastava, Pune (IN)

(21) Appl. No.: 15/063,552

(22) Filed: Mar. 8, 2016

(51) Int. Cl. G06Q 30/02

(52) U.S. Cl. CPC G06Q 30/0269

(57) ABSTRACT

An initial user is selected and social data associated with the user is retrieved. Social contacts within the profile are identified and assessed for association with a product or product type. Social contacts are sorted according to their proximity to the initial user. Target or reference contacts are identified based on product association and proximity.

### BACKGROUND

Aspects of the present disclosure relate to the distribution of materials and information, and more particular aspects relate to using social proximity to direct the distribution of materials and information.

Social networks and other electronic communication platforms provide users with tools for organizing their social contacts. Some of these tools are automatic applications, placing contacts into particular groups according to data available to the application. Others are manual applications, which may allow the user to group their social contacts according to the user's own considerations.

### SUMMARY

Disclosed herein are embodiments of a method and computer system for using social proximity to direct the distribution of materials and information.

According to embodiments of the present disclosure, an initial user is selected to receive an offer associated with a product type and a proximity level. The initial user's profile, comprising social data associated with the initial user, is retrieved from a profile database. The initial user's social contacts are identified within the user profile. The social contacts are assessed for association with the product type and sorted into levels of proximity based on an analysis of the social data in the initial user's profile. Target contacts are identified from the assessed social contacts based on the proximity level associated with the offer and the offer is transmitted to the initial user and the identified target contacts.

According to embodiments of the present disclosure, a keyword, associated with a product, is identified in an electronic communication. The electronic communication is associated with a target user and, in response to identifying the keyword, a computer system identifies a user profile. The user profile, stored in a profile database, is made up of social data associated with the target user. Social contacts are identified within the user profile and assessed for association with the product. The social contacts are also sorted into levels of proximity based on an analysis of the social data in the user profile. The social contacts are ranked according to the strength of their product association and proximity to a target user. A reference contact is identified from the ranking and product information and a notification indicating the reference contact is transmitted to the target user.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual overview of example inward and outward distribution methods according to embodiments of the present disclosure.

FIG. 2 depicts a flowchart of an example method for outward distribution according to embodiments of the present disclosure.

FIG. 3 depicts a flowchart of an example method of evaluating social contacts for outward distribution according to embodiments of the present disclosure.

FIG. 4 depicts a flowchart of an example method for inward distribution according to embodiments of the present disclosure.

FIG. 5 depicts a flowchart of an example method of evaluating and ranking social contacts for inward distribution according to embodiments of the present disclosure.

FIG. 6 depicts an example of a network environment according to embodiments of the present disclosure.

FIG. 7 depicts a block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to the distribution of materials and information, and more particular aspects relate to using social proximity to direct the distribution of materials and information. While the present disclosure is not necessarily limited to such applications, various aspects of the disclosure may be appreciated through a discussion of various examples using this context.

Distribution of materials may begin with an existing customer base and seeks to expand outward to new customers, as people occupying shared social circles may share common needs and interests. When materials are targeted towards people in the social circles of existing customers, there may be a greater chance of the material being received by a person who wants the marketed product. Additionally, potential new customers drawn from the social circles of existing customers have the advantage of a known and trusted reference for the product, or perhaps more generally for the brand, in the existing customer. In certain cases, such as electronics, it may additionally enable social circles to more easily coordinate obtaining compatible products, improving their means of communication and interaction. Social media may support analysis of the social circles to provide information regarding social proximity between a user and their social contacts. Social proximity analysis may provide a useful framework for understanding and utilizing social influence.

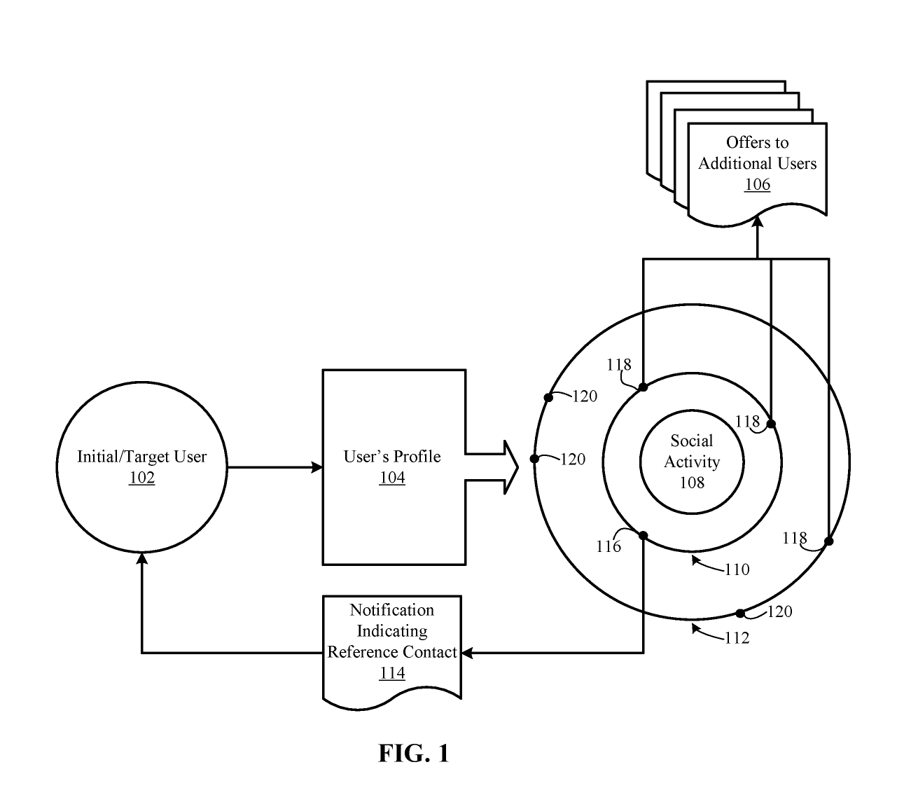

Existing customers may be used to target marketing distributions toward potential new customers in at least two ways, referred to herein as an “inward” method and an “outward” method. A conceptual overview of an example embodiment comparing these two methods can be seen in FIG. 1. Both methods select or identify an initial (outward)/target (inward) user 102 and access a user profile 104 associated with the user 102. The user profile 104 may generally include compiled and analyzed social data pertaining to the initial or target user 102. The user profile 104 may contain the initial or target user's social contacts, as well as both raw and processed data relating to the user's interaction with, and grouping of, their social contacts.

The user's social activity 108 is extracted from the user profile 104 and analyzed to develop proximity levels 110, 112. Proximity levels may be developed based on various factors such as relationships (e.g., spouse, sibling, school or college friend, work colleague, etc.) and frequency of conversation (e.g., hourly, daily, weekly, etc.). The proximity levels may provide a standardized metric of the possible influential effect between the user 102 and a given social contact. Contacts sorted into the first proximity level 110 may have greater potential influential effect than contacts sorted into the second proximity level 112. The embodiment pictured shows only two proximity levels, but other embodiments may contain any number of proximity levels.

In the outward mode, additional target contacts 118 are selected from the user's social contacts to receive a marketing offer 106. A goal of the outward mode is to extend an offer to an initial user 102, and to also draw from the initial user's social contacts additional target contacts 118 who may have an interest in the offer, and may be more receptive to the offer than target users chosen from outside the social circle of the initial user 102.

The inward mode, in contrast, may select a reference contact, e.g. reference contact 116. A notification 114 may then be transmitted to the target user 102, indicating the reference contact 116 to the target user 102. Using the inward mode, a goal is to draw from the social contacts of the target user 102 a contact, the reference contact 116, which may provide the target user 102 with trusted and positive feedback on the product. One or more reference contacts 116 may be selected depending on the number and quality of suitable candidates in the target user's 102 social contacts. Some contacts may be unsuitable candidates for either mode, as seen in the figure as unselected contacts 120.

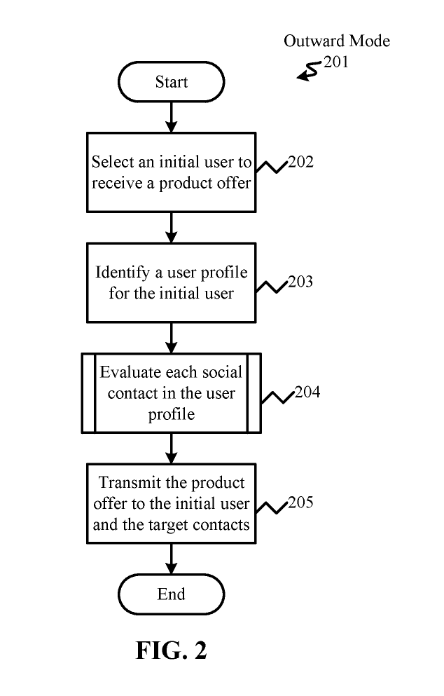

FIG. 2 depicts a flowchart of an example method 201 for the outward mode. Following the example method 201 for the outward mode, an initial user may be selected to receive a product offer, as shown in operation 202. The initial user may be selected from an existing list or database of potential recipients. The outward mode may generally be an event-based method, executed following the creation of an event, an offer, or the list or database. The event may, in some embodiments, be a marketing campaign and the offer, likewise, may be a price reduction or other special sale of the product.

In some embodiments, the remainder of outward mode 201 (i.e. operations 203, 204, and 205) may occur in response to a selection of the initial user in operation 202. The marketing offer may be associated with a particular product, the product itself associated with a particular product type. For example, the product may be a tablet or a cell phone, in which case the product type could be electronics. The marketing offer may be a price reduction or other incentive for purchase of the tablet or cell phone. In some embodiments, the marketing offer may also be associated with a particular proximity level, where the proximity level may be applied during the method as one element for the determination of additional contacts to receive the marketing offer. For instance, the marketing offer may be associated with a second proximity level, in which case contacts falling within the first and second proximity level may be considered as possible candidates to receive the offer, while contacts in a third proximity level or outward may be dismissed as inappropriate candidates to receive the offer.

In operation 203, a user profile for the initial user is identified. The user profile may consist primarily of assembled social data relevant to the user, which may include social contact information. The social contact information may include the user's organization of their social contacts and analysis of the user's online social activity. In some embodiments, the analysis of the social data may include analysis of the user's grouping of the social contacts and recorded online interactions between the user and their social contacts. The user profile may be stored in and retrieved from a database, which may be stored on a local server or accessed via a network. The user profile may also be assembled at the time the initial user is selected.

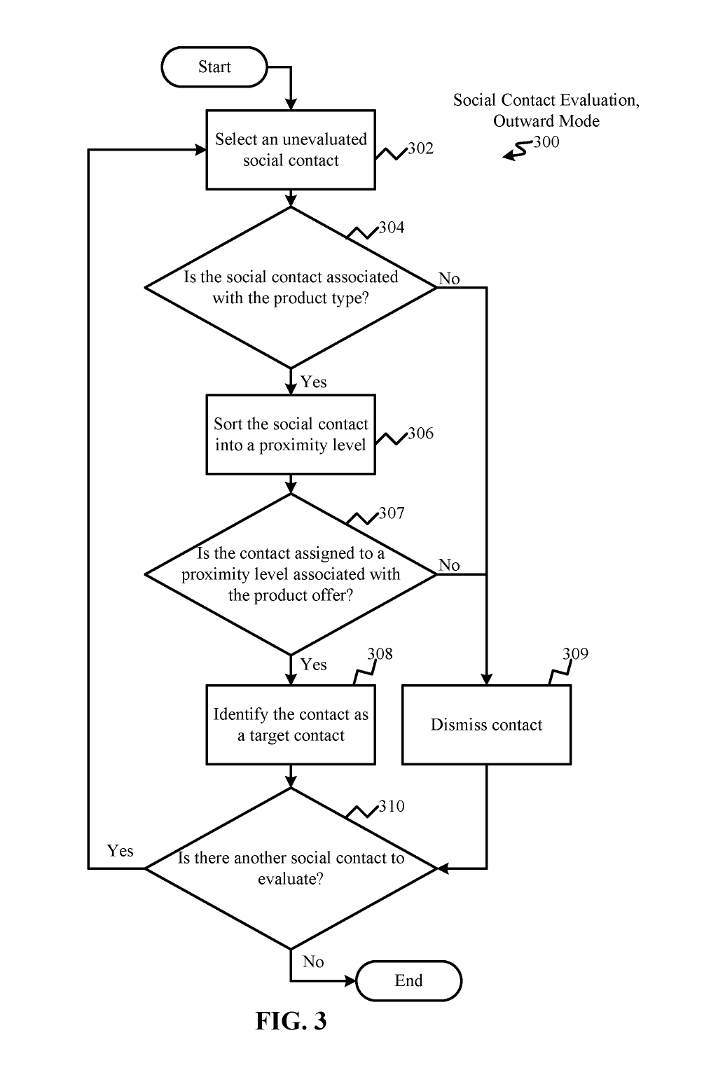

Each of the social contacts found in the initial user's user profile may be evaluated through operation 204, a subprocess further developed in FIG. 3, to identify target contacts. In operation 205, the product offer is transmitted to the initial user and to identified target contacts, completing outward method 201. Transmitting the product offer may be accomplished in any number of ways, but in some embodiments may be part of a mail or email marketing campaign. In other embodiments, the user and target contacts may be transmitted to an external system, for example a social media server, and used for targeted marketing offers executed by the external system. Transmission may include, among others, an email or other electronic messaging medium, such as instant messaging, social media messaging, or other communication means provided by a social media, blogging, or other online communications site. The transmission may be received via an electronic messaging system or other notification format present on a social media, blogging, or other online communication site.

In some embodiments, the product offer may include a variable serving as a placeholder within the offer until the target contacts are identified. The variable may provide for implementation of the method and personalization of the product offer by allowing the offer to be prepared ahead of time, and populated with the additional target contacts at a later time. The variable may serve as a placeholder in the body of the marketing offer during the evaluation of the social contacts and identification of appropriate target contacts. For example, an offer may be prepared as an electronic letter or flyer, with a variable occupying a [Name] field. As the target contacts are identified, the variable can be replaced with the name of an identified target contact. A target contact may be substituted for the variable at the time of transmission, or at any other time once the target contact is identified. The form of the variable is not limited by the method, and may be any appropriate placeholder in the product offer. Embodiments incorporating a variable may facilitate combining the outward mode with existing campaign management strategies or coordinating with external systems.

Each social contact from the initial user's profile may be evaluated according to several factors in order to provide accurate and relevant offers to the target contacts selected using the outward mode. FIG. 3 depicts a flowchart of an example method 300 for evaluating the social contacts. The method 300 may be used to perform operation 204 of FIG. 2.

An unevaluated social contact may be selected in operation 302. In operation 304, the selected contact is evaluated for association with the product type associated with the offer. For example, a social media contact (e.g., a friend) of the intial user may be evaluted for a level of association with the offer (e.g., has the contact purchased this product before). In some embodiments, a social contact may be identified as associated with the product based on searching the social contact's user profile for data indicating interest in the product type. The data indicating interest in the product type may include a textual statement of interest made on a social media site, a statement of interest made on a blog site, or another explicit or implicit statement of interest. A contact may also be assessed for ostensible interest in the broader product type associated with the marketing offer. For instance, in some embodiments the marketing offer may pertain to an electronics item, such as a tablet or a gaming system. A social contact from the initial user's profile may be evaluated for evidence of interest in the product type of electronics, rather than the specific product, e.g. the tablet, of the offer. A contact determined to lack an association with the product type may be dismissed as an inappropriate candidate for selection as a target contact, seen in operation 309. A contact determined to have an association with the product type may be accepted as a target contact or further evaluated if further criteria, such as proximity level, is to be used for assessment.

The selected contact may also be sorted into a proximity level, as seen in operation 306. The appropriate proximity level for the evaluated social contact may be determined by applying factors, as discussed above, to analysis of the user's social data. In operation 307, it is determined whether the contact is assigned to a proximity level associated with the product offer. In some embodiments, the marketing offer may be associated with a proximity level and the social contact may then be filtered according to whether the proximity level a social contact is sorted into corresponds to the proximity level associated with the product offer. For example, a marketing campaign may be designed to be distributed to the initial user's first proximity level. In this example, a social contact sorted into the first proximity level would be assessed as a potential target contact, but if the contact were sorted into another proximity level it could be dismissed. A social contact sorted into a proximity level that is not associated with the marketing offer may be dismissed as an inappropriate candidate for selection as a target contact, as in operation 309. A social contact sorted into a proximity level that is associated with the marketing offer may be identified to be an appropriate target contact, per operation 308.

Following the completed evaluation of the selected contact, a determination may be made, shown in operation 310, of whether another social contact remains to be evaluated. If not, operation 205 of outward mode method 201 may proceed. If additional social contacts remain to be evaluated, operation 302 is repeated to select and evaluate a remaining unevaluated social contact.

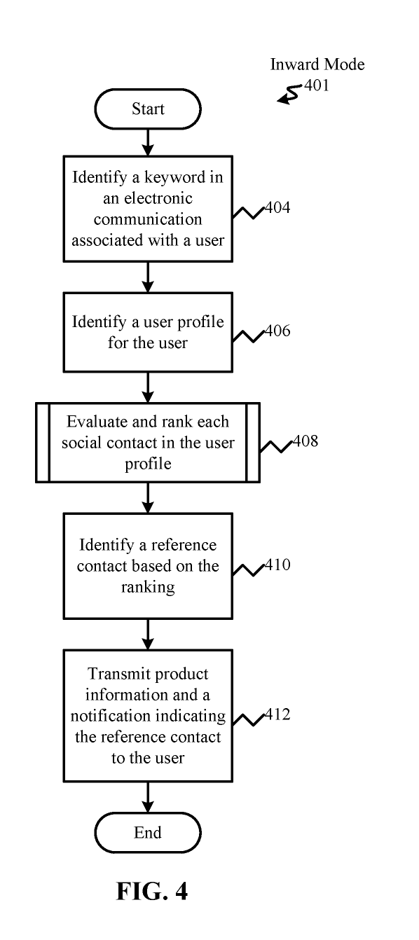

In embodiments, an inward method may be used to more precisely target product marketing to a selected user. In some embodiments, the inward mode may be directed toward providing the target user with alternatives to the product for which the target user has searched. The product information may simply be a description of the product, or may additionally describe why the product may be an appropriate candidate for their product search. Other embodiments may provide product information alongside an offer, within an offer, or not at all. An example method 401 of the inward mode is shown in the flowchart of FIG. 4.

When executing the inward mode, a target user may be selected through the identification of a keyword in an electronic communication associated with a user, shown in operation 404. In contrast to the generally event-based model of the outward mode, the inward mode may generally be more trigger-based, for example executing when triggered by the identification of a keyword in an electronic communication. Receiving the electronic communication containing the keyword may occur in several ways. For example, the electronic communication may be a query entered into an internet search engine by a user. In embodiments, it may be posts, comments, or other communications made by a user on a social media site or a blog site. In some embodiments, the electronic communications may be received from an external system, for instance a search engine server or a social media server. The electronic communication may be received as it is identified to contain the keyword, or may be held by the external system and transmitted periodically. In other embodiments, a search or poll may be performed to seek out electronic communications containing the keyword. Once the keyword is identified within an electronic communication, the electronic communication may be associated with the originating user. The originating user may then become the target user of the inward mode 401.

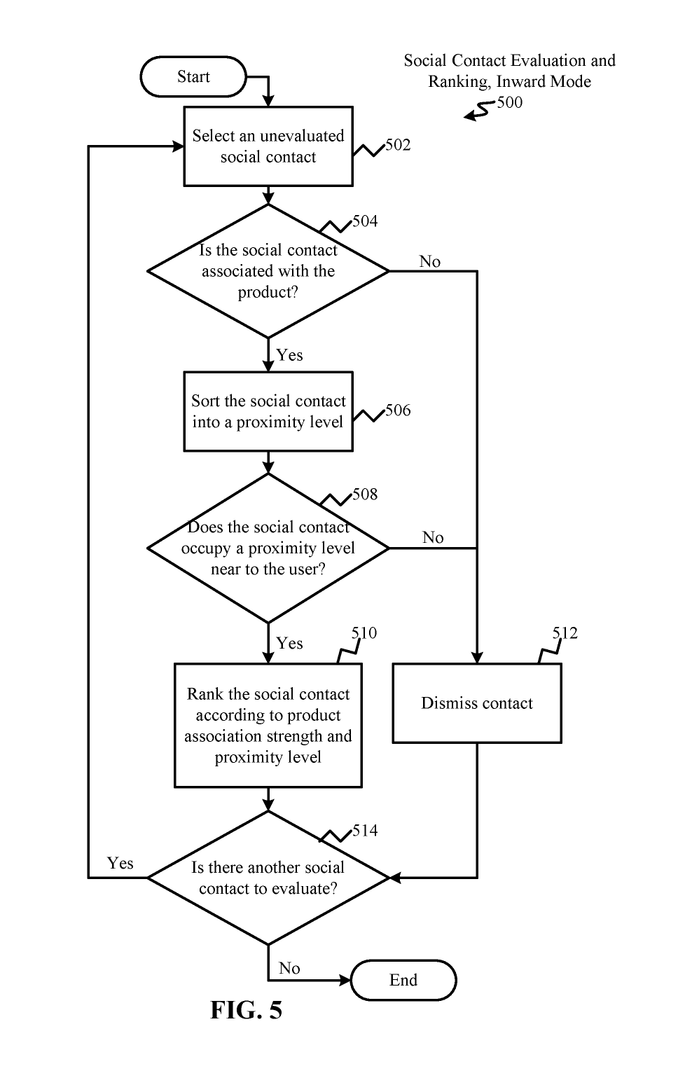

In operation 406, the user's profile is identified, and in some embodiments the profile may be found within a profile database. The user profile data associated with the electronic communication may be received along with the electronic communication, or identified and retrieved after the electronic communication is received. The user profile may be preassembled from social data associated with the user and analysis of that social data or, in other embodiments, the social data may be retrieved and processed at the time the user is identified or received from an external system. The social data will generally include the user's social contacts, which are evaluated and ranked during operation 408, a subprocess shown with greater detail in FIG. 5. The evaluation and ranking may generally take into account factors such as contact's association with the product and closeness to the user, as assessed using proximity levels.

A reference contact is identified from the ranked social contacts in operation 410. The reference contact may generally be a top-ranked contact, having been assessed to be both strongly and, in some embodiments, positively associated with the product, and a social contact occupying a proximity level close to the user. In operation 412, product information may be transmitted to the user along with a notification providing an indication of the reference contact.

Transmission may include use of email or other electronic messaging, or preparing a physical brochure or other marketing items for mailing. Alternatively, transmission may involve providing the user and reference contact information to an external system, for example a social media or blog server, to permit the external system to facilitate communication with the user regarding the product information and the reference contact. As another alternative, the transmission may involve the system itself sending a message through a social media server or a blog server to the associated social media site or blog site. In some embodiments the notification may include a variable. A reference contact may be substituted for the variable at the time of transmission or at any other time a suitable reference contact is identified.

The flowchart of FIG. 5 depicts an example method 500 for evaluating and ranking the social contacts, such as for the inward method 401 of FIG. 4. The method 500 may be used to perform operation 408 of FIG. 4.

A social contact from the user's profile is selected in operation 502. The selected social contact may be evaluated according to several factors. In operation 504, the social contact is assessed to determine if the social contact is associated with the product. The social contact may be evaluated for association with a particular product, as opposed to a general product type. Further, in some embodiments, the social contacts may be subject to an assessment for knowledge of and positive attitude toward the particular product. Attitude and knowledge may be quantified in any number of ways, but in some instances may be determined based on the social contact's ownership of the particular product or their own postings on social media or blogs. The social contact may be found to have a purchase history including the product or the social contact may be associated with the product through an electronic post expressing knowledge of or a positive opinion towards the product. The electronic post may be a post on a social media site or a post on a blog or any other online forum.

If the social contact is assessed to be unassociated with the product, the social contact may be dismissed, per operation 512, as an inappropriate candidate for a potential reference contact. If the social contact is assessed as being associated with the product, they may be ranked, accepted, or further evaluated.

During the evaluation and ranking of the inward mode, the social contact may be sorted into a proximity level, per operation 506. In operation 508, the social contact may be assessed for the nearness of their occupied proximity level to the target user. Nearness may be assessed based on comparison to a preset value to determine closeness, such as a particular proximity level, or the value may be set at the time of assessment using factors such as the number of social contacts in the user profile. A contact determined to be in a proximity level too far from the user to be an appropriate reference contact may be dismissed, as in operation 512. A social contact assigned to a proximity level deemed to be acceptable for a reference contact may be ranked, accepted, or further evaluated if further criteria is to be used.

The evaluated contacts may be ranked against other evaluated contacts, shown in operation 510, according to the strength of their association to the product and how close their proximity level lies to the target. The social contacts are ranked to determine which of the evaluated contacts are most suitable to be a reference contact. Operation 514 determines whether a social contact remains to be evaluated so that each social contact is evaluated before the method 500 is complete.

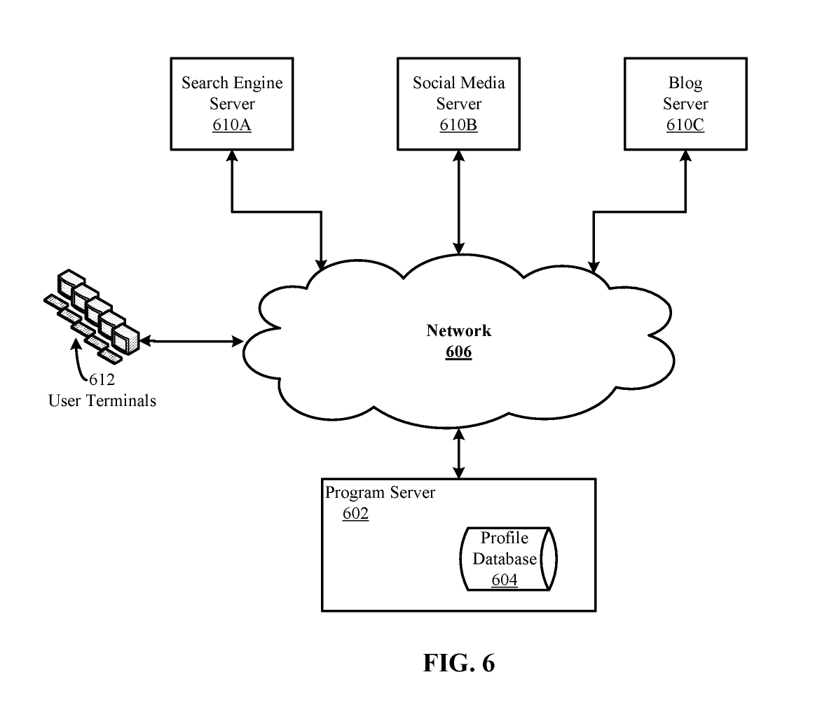

Embodiments of the present disclosure may be implemented through the use of a network, such as the network depicted in FIG. 6. The network 606 may be the internet in some embodiments, in others an internal network receiving data from additional external networks, or any other form of digital communication network. The network 606 may serve to allow the program server 602 to transmit electronic communications, such as the offer 106 or the notification 114, to user terminals 612. The network may also connect the program server 602 to search engine servers 610A, social media servers 610B, or blog servers 610C, providing the program server 602 access to social data and electronic communications from remote servers 610A, 610B, and 610C.

Program server 602 may be any computing system or combination of computing systems. In some embodiments, program server 602 may be implemented in a cloud computing environment.

The social data and electronic communications may be provided to the program server 602 in a number of ways, but in some embodiments the data and communications may be received through subscription or purchase. In other embodiments, the social data and relevant electronic communications may be identified by periodic polling or text mining of the search engine server 610A, the social media server 610B, or the blog server 610C by the program server 602 via the network 606. The social data may generally consist of the user's social contacts and the user's own arrangement and grouping of their social contacts, but additionally may include discussion text, posts, and comments; search engine queries; communication frequency and duration particular to each contact; history of each social contact, such as duration of the connection and any status changes; or social data relating to the social contacts independent of the user.

Though in some embodiments a profile database 604 may be stored on the program server 602 itself, the profile database 604, and most other data used for the methods, may also generally be accessed via the network 606. The profile database 604 may generally contain preassembled user profiles, but in some embodiments may contain data only assembled into user profiles following the identification of the initial or target user, or following the receipt of social data from the search engine server 610A, the social media server 610B, the blog server 610, or some combination of the three. In other embodiments, the user profile may be received preassembled or partially assembled from one or more of the servers 610A, 610B, and 610C, and in some such embodiments the profile database 604 may not be present.

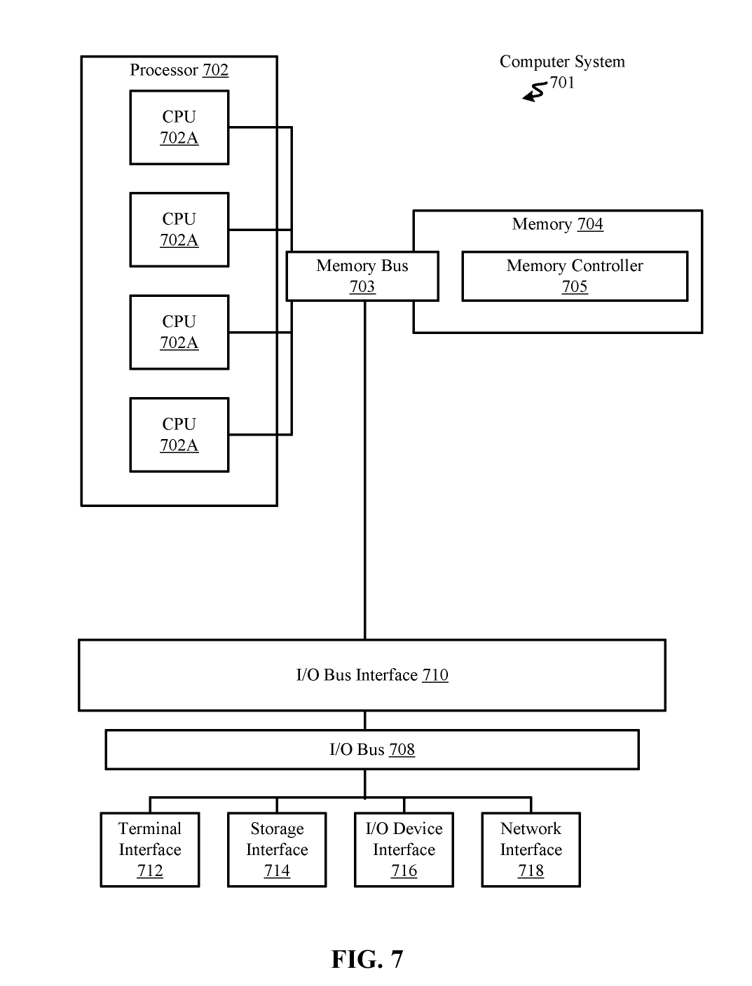

Referring now to FIG. 7, shown is a high-level block diagram of an example computer system (i.e., computer) 701 that may be used in implementing one or more of the methods or modules, and any related functions or operations, described herein (e.g., using one or more processor circuits or computer processors of the computer), in accordance with embodiments of the present disclosure. For example, computer system 701 may be used to implement the methods described in reference to FIGS. 2-5 and program server 602 described in reference to FIG. 6. In some embodiments, the major components of the computer system 701 may comprise one or more CPUs 702, a memory subsystem 704, a terminal interface 712, a storage interface 714, an I/O (Input/Output) device interface 716, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may comprise one or more levels of on-board cache.

In some embodiments, the memory subsystem 704 may comprise a random-access semiconductor memory, storage device, or storage medium (either volatile or non-volatile) for storing data and programs. In some embodiments, the memory subsystem 704 may represent the entire virtual memory of the computer system 701, and may also include the virtual memory of other computer systems coupled to the computer system 701 or connected via a network. The memory subsystem 704 may be conceptually a single monolithic entity, but, in some embodiments, the memory subsystem 704 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 704 may contain elements for control and flow of memory used by the CPU 702. This may include a memory controller 705.

Although the memory bus 703 is shown in FIG. 7 as a single bus structure providing a direct communication path among the CPUs 702, the memory subsystem 704, and the I/O bus interface 710, the memory bus 703 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 571 may be implemented as a desktop computer, portable computer, laptop or notebook computer, tablet computer, pocket computer, telephone, smart phone, mobile device, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
selecting an initial user to receive an offer, the offer associated with a product and a proximity level, the product associated with a product type;
identifying a user profile for the initial user in a profile database, the user profile comprising social data associated with the initial user;
identifying social contacts, associated with the product type, in the social data associated with the initial user;
sorting the social contacts into levels of proximity based on an analysis of the social data associated with the initial user;
identifying target contacts from the sorted social contacts based on the proximity level associated with the offer; and
transmitting the offer to the initial user and the identified target contacts.

2. The method of claim 1, wherein identifying the user profile, identifying the social contacts, sorting the social contacts into levels of proximity, identifying target contacts, and transmitting the offer, occur in response to selecting the initial user to receive an offer.

3. The method of claim 1, wherein the analysis of the social data associated with the initial user comprises analysis of social contact grouping and online interactions between the initial user and the social contacts.

4. The method of claim 1, wherein the offer includes a variable.

5. The method of claim 4, wherein an identified target contact is substituted for the variable at the time of transmission.

6. The method of claim 1, wherein social contacts are identified as associated with the product based on searching user profiles for each of the social contacts for data indicating interest in the product type.

7. The method of claim 6, wherein the data indicating interest in the product type comprises a textual statement of interest made on a social media site.

8. The method of claim 6, wherein the data indicating interest in the product type comprises a textual statement of interest made on a blog site.

9. A method comprising:
identifying a keyword in an electronic communication, the keyword associated with a product, the electronic communication associated with a target user, the product associated with product information; and
in response to identifying the keyword associated with the product in the electronic communication associated with the target user:
identifying a user profile associated with the target user in a profile database, the user profile comprising social data associated with the target user;
identifying social contacts, associated with the product, in the social data associated with the target user;
sorting the social contacts into levels of proximity based on an analysis of the social data associated with the target user;
ranking the contacts according to product association strength and target user proximity;
identifying a reference contact based on the ranking of the contacts; and
transmitting, to the target user, the product information and a notification indicating the reference contact.

10. The method of claim 9, wherein the electronic communication is a query using an internet search engine.

11. The method of claim 9, wherein the electronic communication is a post on a social media site.

12. The method of claim 9, wherein the electronic communication is a post on a blog.

13. The method of claim 9, wherein contacts associated with the product are identified by having a purchase history including the product.

14. The method of claim 9, wherein contacts associated with the product are identified by knowledge of the product expressed in an electronic post.

15. The method of claim 14, wherein the electronic post is a post on a social media site.

16. The method of claim 14, wherein the electronic post is a post on a blog.

17. The method of claim 9, wherein the notification includes a variable.

18. The method of claim 17, wherein the reference contact is substituted for the variable at the time of transmission.

19. A computer system comprising:
a memory; and
a processor in communication with the memory, wherein the computer system is configured to perform a method, the method comprising:
selecting an initial user to receive an offer, the offer associated with a product and a proximity level, the product associated with a product type;
identifying a user profile for the user in the database, the user profile comprising social data associated with the initial user;
identifying social contacts of the initial user, associated with the product type, in the social data associated with the initial user;
sorting the social contacts of the initial user into levels of proximity based on an analysis of the social data associated with the initial user;
identifying target contacts from the social contacts of the initial user based on the proximity level associated with the offer; and
transmitting the offer to the initial user and the identified target contacts.

20. The computer system of claim 19, wherein the computer system is further configured to perform a second method, the second method comprising:
identifying a keyword in an electronic communication, the keyword associated with the product, the electronic communication associated with a target user, the product associated with product information; and
in response to identifying the keyword associated with the product in the electronic communication associated with the target user:
identifying a second user profile in the profile database, the second user profile comprising social data associated with the target user;
identifying social contacts of the target user, associated with the product, in the social data associated with the target user;
sorting the social contacts of the target user into levels of proximity based on an analysis of the social data associated with the target user;
ranking the social contacts of the target user according to product association strength and user proximity;
identifying a reference contact based on the ranking of the social contacts of the target user; and
transmitting, to the target user, the product information and a notification indicating the reference contact.
